(19) United States
(12) Patent Application Publication
(10) Pub. No.: US 2004/0192133 A1
(43) Pub. Date: Sep. 30, 2004

(54) Abrasion and heat resistant fabrics

(75) Inventors: Young Hwa Kim, Hudson, WI (US); Hong Ji, Woodbury, MN (US)

Correspondence Address: Linda P. Ji, Westman, Champlin & Kelly, Suite 1600, 900 Second Avenue South, Minneapolis, MN, 55402-3319, US

(73) Assignee: Higher Dimension Medical, Inc., Oakdale, MN (US)

(21) Appl. No.: 10/734,686

(22) Filed: Dec. 12, 2003

Related U.S. Application Data
(63) Continuation-in-part of application No. 09/610,748, filed on Jul. 6, 2000.

(51) Int. Cl. B32B 3/06; D04H 3/00; B32B 9/04; D04H 13/00; B32B 27/12; B32B 27/04; B32B 5/02; B32B 9/00; D04H 1/00; B32B 27/38; D04H 5/00

(52) U.S. Cl. 442/148; 442/156; 442/175; 428/103; 428/911

(57) ABSTRACT

The present inventions introduce fabrics having an array of closely spaced, non-overlapping plates. The inventive fabrics are both mechanically strong yet highly flexible and can be used in applications requiring a high degree of abrasion, wear, cut, tear, and puncture resistance, and optional, heat resistance. The inventive fabrics can be useful in fabric applications such as gloves, garments, aprons, knee pads, luggage, tarps, and roofs for convertible cars.

### CROSS-REFERENCE TO RELATED APPLICATION

The present application is a continuation in part of and claims priority of U.S. non-provisional patent application 09/610,748 filed Jul. 6, 2000, the contents of which are hereby incorporated by reference in their entirety.

### BACKGROUND OF THE INVENTION

Conventional fabrics are often easily frayed or damaged when they abrade against the rough surfaces of hard objects such as coarse cement, rocks, and asphalt. Yarns and fibers, especially on the surface of fabrics tend to abrade, lose mass, or even melt due to the heat of friction when exposed to relatively high abrasion conditions.

High-performance fabrics have been developed for some abrasion applications. One approach is to tightly weave high denier yarn (e.g. nylon, polyester, etc.) into a fabric. Thermoplastic coatings to can be applied to such fabrics to enhance abrasion resistance. Various high strength fibers (e.g. Kevlar® and PBO) are sometimes used in high performance fabrics. However, these high strength fibers tend to be brittle, and therefore, are not associated with exceptional abrasion performance in many applications.

Further, many current high performance or abrasion resistant fabrics are bulky and stiff. Moreover, many abrading objects have sharp or pointed features (e.g. tree branches or rocks) that can snag the fabric and cause failure from tearing or puncturing.

One fabric that is commonly used for abrasion resistance is leather (e.g. in jackets, footwear, or furniture). Leather is soft and supple and generally has good abrasion resistance at relatively low abrasion. However, the softness of the leather's surface makes it vulnerable to failure from relatively high intensity abrasion. For example, a motorcycle crash generally results in relatively high intensity abrasion due to the force of impact and the road surface. Such high intensity abrasion can cause failure in leather jackets and pants often worn by motorcyclists.

There is currently a need for better high-performance fabrics that are appropriate for both low and high intensity abrasion that are also cut, puncture and/or tear resistant. There is a need for such fabrics that can provide heat insulation or resistance.

### SUMMARY OF THE INVENTION

The present inventions introduce fabrics having an array of closely spaced, non-overlapping plates. The inventive fabrics are both mechanically strong yet highly flexible and can be used in applications requiring a high degree of abrasion, wear, cut, tear, and puncture resistance, and optional, heat resistance. The inventive fabrics can be useful in fabric applications such as gloves, garments, aprons, kneepads, luggage, tarps, and roofs for convertible cars.

### BRIEF DESCRIPTION OF THE DRAWINGS

FIG. 1 is an isometric view of one embodiment of the inventive fabric assembly.

FIG. 2 is an enlarged view of the fabric assembly illustrated in FIG. 1.

FIG. 3 is an enlarged plan view of the embodiment illustrated in FIG. 1.

FIG. 3A is a section taken along line A-A of FIG. 3.

FIG. 3B is a section taken along line B-B of FIG. 3.

FIG. 4 is an alternate embodiment of the inventive fabric assembly.

FIG. 5 shows an object abrading on the surface of the inventive fabric assembly.

FIG. 6 shows an object abrading on the surface of the inventive fabric assembly with a compressible substrate.

FIG. 7 shows a cross-section view of plates permeating and affixed to flexible substrate.

FIG. 8A shows a cross-section view of plates affixed to flexible substrate with an adhesive layer applied to the entire substrate.

FIG. 8B shows a cross-section view of plates affixed to flexible substrate with adhesives applied at the interface between the plates and the substrate.

FIG. 9 shows an alternate embodiment of the inventive fabric assembly having a composite substrate.

FIG. 10 shows a flowchart illustrating steps of a method of the present inventions.

FIG. 11 shows a flowchart illustrating steps of an alternative method of the present inventions.

FIG. 12 illustrates an application where the present embodiments are useful.

### DETAILED DESCRIPTION OF THE PREFERRED EMBODIMENTS

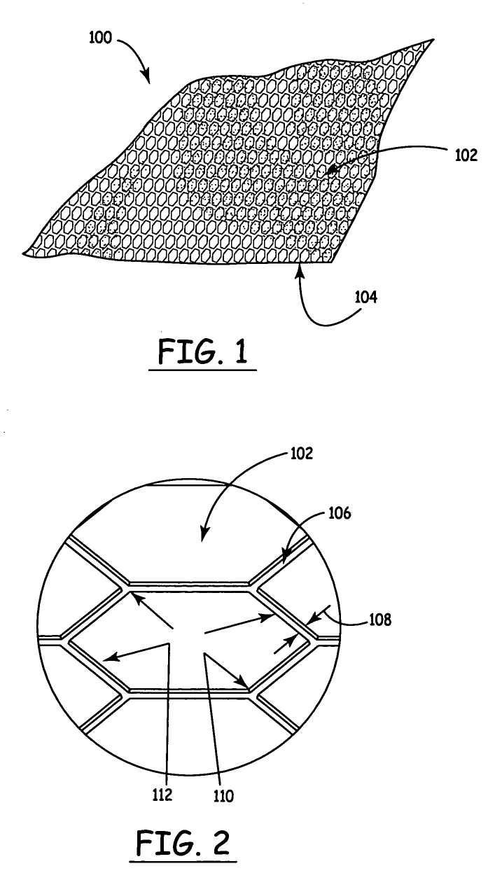

FIG. 1 is an isometric view of one embodiment of the abrasion and wear-resistant fabric or fabric assembly of the present inventions. A plurality of plates 102 is affixed to a top surface of flexible substrate 104. The plurality of plates 102 enhance the abrasion and wear resistance of substrate 104.

Depending on application, abrasion resistance can range from low intensity rubbing typical of garments repeatedly worn and laundered, to high intensity abrasion (high loading and/or high speed) such as for luggage or garments worn to provide protection in, for example, motorcycle riding. It is noted that the fabrics of the present invention can be heat resistant, which is meant to include fabrics that are relatively heat tolerant and heat insulating.

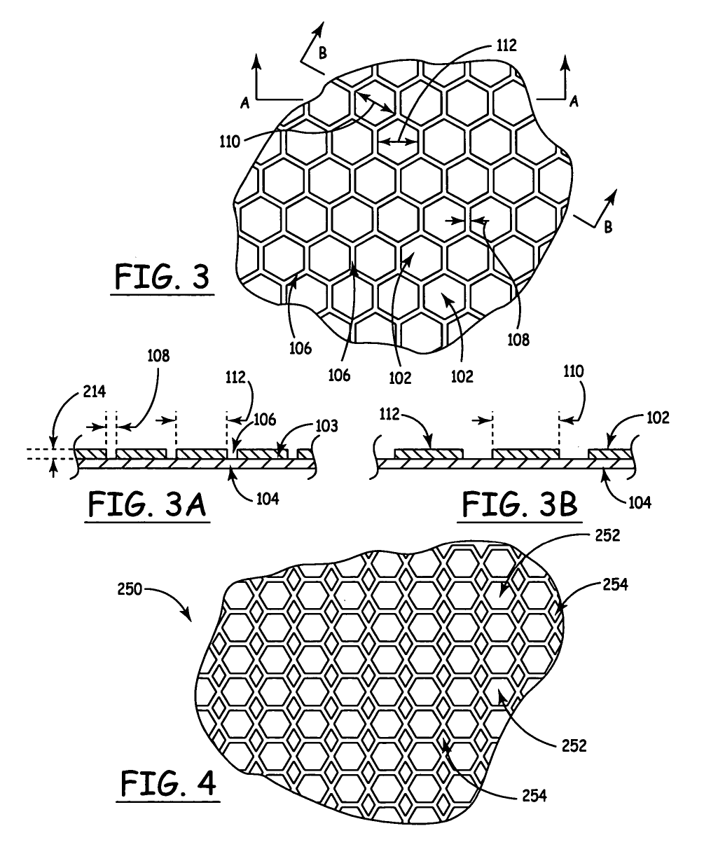

FIGS. 2 and 3 illustrate enlarged isometric and plan views, respectively, of the fabric assembly shown in FIG. 1. Plurality of plates 102 are non-overlapping and are arrayed and affixed on the top surface of the flexible fabric substrate. Plates 102 define a plurality of gaps 106 between adjacent plates 102. Gaps 106 are continuous and inter-linking and each has a selected width so that the fabric assembly 100 retains flexibility for use in articles such as garments, aprons, boots, gloves, luggage, roof material for convertible cars and other items, while simultaneously inhibiting objects from abrading directly against and degrading fabric substrate 104.

Another advantage of the fabric assembly of the present invention is that its fabric-like flexibility allows the fabric assembly to be bent, folded or rolled like ordinary fabric, thereby simplifying manufacturing and storage. Also, the fabric can be used in applications requiring a relatively high degree of dexterity such as work gloves.

FIGS. 2-4 illustrate various plate dimensions that can be selected for a selected or desired abrasion and/or wear resistance and optional heat resistance. Plates 102 have an approximately uniform thickness 214 (shown on FIG. 3A) that is in the range of 5 to 40 mils in some embodiments. In other embodiments, plates 102 have an approximately uniform thickness in the range of 5 to 20 mils. Plates 102 each have a maximum dimension 110 (illustrated in FIGS. 2, 3 and 3B) which is the maximum dimension between two points on the top surface of plate 102. It is important to note that although plates 102 can be shaped as identical regular hexagons each having diameter 112, plates 102 can be embodied in any regular or non-regular shape, and be identical or non-identical to one another. In some embodiments, the maximum dimension 110 is in the range of 20 to 200 mils for any plate shape, including hexagonal.

For instance, plates 102 can have any polygonal shape such as a square, rectangle, octagon, or a non-regular polygon shape. Plates 102 can also have any curved shape such as a circle, ellipse, or a non-regular curved shape. Finally, plates 102 can be embodied as a composite shape or combination of any regular or non-regular polygon and/or any regular or non-regular curved shape (shown in FIG. 4).

Gaps 106 are continuous due to the non-overlapping characteristics of plates 102. Gaps 106 also have a width that can be approximately uniform or non-uniform. However, generally, the gap width 108 (illustrated in FIGS. 3 and 3A) is in the range of approximately 5 to 20 mils, which is the same range provided for plate thickness 214. In other embodiments, both gap width 108 and plate thickness 214 is in the approximate range of 5 to 40 mils. The co-extending ranges for gap width 108 and plate thickness 214 have been found to be an appropriate compromise between adequate flexibility and adequate mechanical strength against outside forces (i.e. abrasion, wear, puncture, cut and tear resistance) as well as providing optional heat resistance.

FIG. 4 shows fabric assembly 250 having a plurality of non-identical plates 252, 254 where plates 252 have a different shape than plates 254. In this embodiment, plates 252 have a hexagon shape and plates 254 have a diamond shape. However, the embodiment illustrated in FIG. 4 is illustrative only and other combinations of shapes for plates 252, 254 can be used. Further, more than two different shapes can be used.

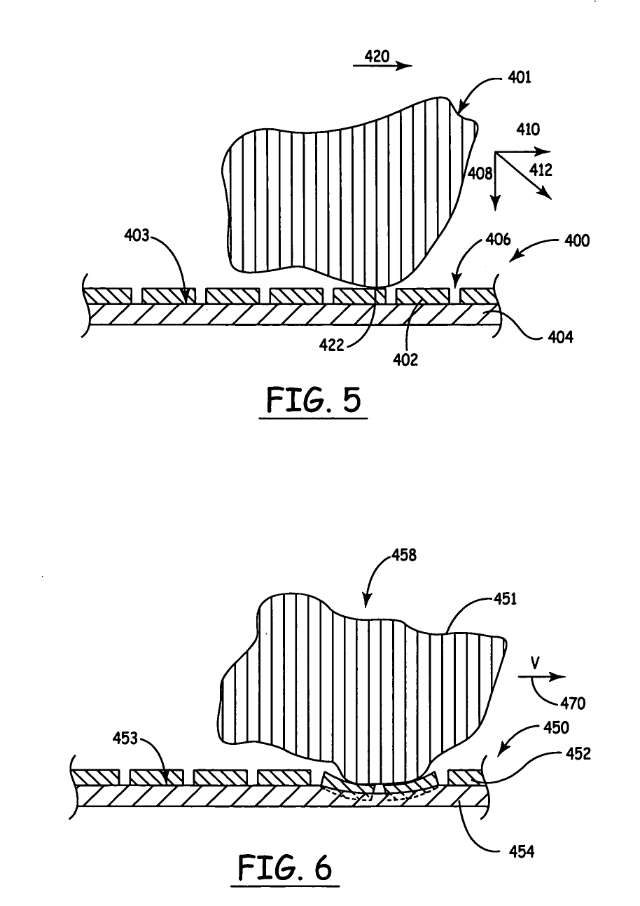

FIG. 5 illustrates an object 401 abrading on the surface of fabric assembly 400 having plates 402 affixed on the top surface 403 of flexible substrate 404 as in the present inventions. Object 401 abrades or applies force against the fabric assembly 400 as indicated by arrow 412 having both a horizontal component 410 and vertical component 408. Object 401 moves across the plates 402 with a velocity 420, which has correlation or is associated with magnitude of horizontal component 410.

Abrasion is a complex phenomenon or process and is influenced, for examples, by the types of materials that are being abraded, the surface characteristics, the relative speed between surfaces, lubrication, and the like. There exist many standardized abrasion tests designed to reflect many varied abrasion conditions. One typical test is the ASTM D 3884. In this test, two round-shaped wheels with specified surface characteristics apply pressure and rotate on the surface of the test sample with a given speed under a predetermined load (e.g. up to 1000 g) . Test results are given either as the number of cycles for the fabric to wear through or as the fabric's weight loss after a fixed number of cycles.

Unfortunately, standardized abrasion tests are often limited due to the limited loading level and speed that can be applied against test fabric. Due to these limitations, other tests are developed to more closely simulate real world conditions. For example, one test can comprise washing fabric continuously in a washing machine containing rocks to test fabrics such as used in backpacks or jeans. In another example, fabric can be wrapped around a concrete weight and thrown from a speeding vehicle to test fabrics used in employed in protective garments worn by motorcycle riders and the like.

In some embodiments, the affixed plates enhance the abrasion and wear resistance of the flexible substrate fabric by a factor F. A factor F is the ratio of abrasion and/or wear resistance of the fabric assembly to that of the flexible substrate. Thus, assuming the abrasion resistance of the flexible substrate is A1 and the abrasion resistance of the fabric assembly is A2, then the enhancement factor is given by

$$F = \frac{{A}_{2}}{{A}_{1}} .$$

It is noted that the factor F can be the ratio of any measurement that is associated or correlated with abrasion and/or wear resistance. In one embodiment, the number of cycles sustained before failure when tested in a typical abrasion and wear resistance testing machine increased fifteen-fold. Thus, the enhancement factor would be approximately 15 in the example provided.

The enhancement factor can be influenced by selecting various substrate fabrics, guardplate shape and dimensions such as thickness, gap width, plate diameter or maximum dimensions. The enhancement factor can generally range from 2 to 200 depending on various selections made. In other embodiments, the enhancement factor can range from 5 to 100, 10 to 50, and 12 to 30, respectively.

FIG. 6 shows an abrading object 451 applying downward force 458 and moving across the surface of fabric assembly 450 at velocity 470. In fabric assembly 450, plates 452 are affixed to top surface 453 of flexible substrate 454. Flexible substrate 454 is a compressible material such as a relatively thick woven or knit fabric comprising materials such as polyester, cotton, Kevlar® or nylon, or combinations thereof. Other compressible materials can include elastomeric materials such as rubber or similar elastomeric materials.

As object 451 abrades on plates 452, the plates 452 are pushed downward into compressible substrate 454, which tends to lessen the tendency to delaminate from the top surface 453 of substrate 454. Thus, a compressible substrate 454 can increase the overall abrasion and/or wear resistance of the fabric assembly 450.

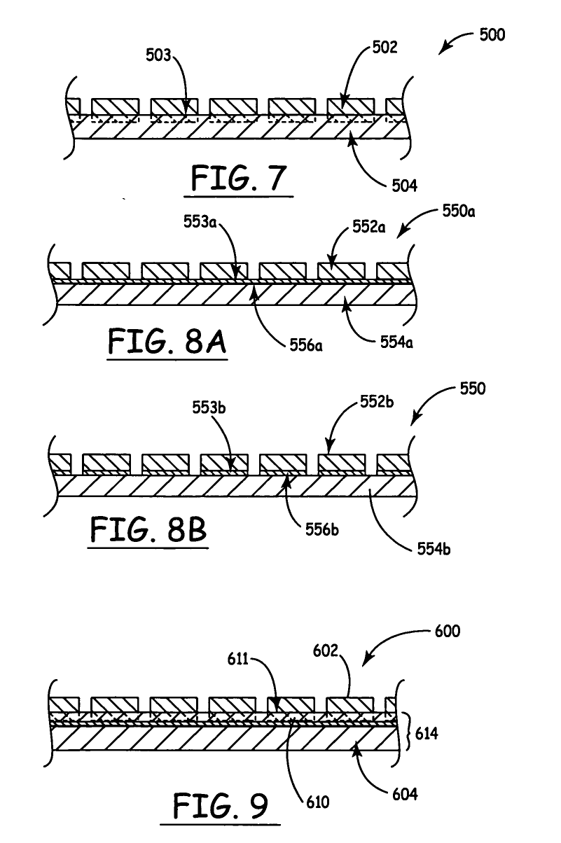

FIGS. 7 to 8B are illustrative of various embodiments for plates affixed to the top surface of a flexible substrate. In FIG. 7, a plurality of plates 502 is affixed to top surface 503 of flexible substrate 504. Plates 502 comprise a material that can be printed on the substrate 504, such as by typical screen-printing. In these embodiments, the plate material is applied in a wet form and slightly permeates and affixes to top surface 503. In these embodiments, a separate adhesive layer is not necessarily required. Plate material includes resins such as epoxy resins, phenol-based resins, and other like substances. Such materials can require heat or ultraviolet curing.

FIG. 8A is illustrative of embodiments having a plurality of plates 552a affixed to top surface 553a of substrate 554a via or through adhesive layer 556a. In these embodiments, the adhesive layer is continuous and covers the entire surface of substrate 554a. FIG. 8B is illustrative of embodiments having a plurality of plates 552b affixed to top surface 553b of substrate 554b via or through a discontinuous adhesive layer 556b. The adhesives are only applied between plates 552b and substrate 554b. In these embodiments, plates 552a or 552b can be made of materials that are hard and solid when applied. Examples of such materials can include ceramics, glass, plastics, metals and other hard and/or composite materials.

In other embodiments having exceptional heat resistant properties, plates 552a, 552b affixed to the substrate 554a, 554b comprise relatively low thermal conductivity materials. One embodiment of such materials is porous ceramic made of silica glass fiber with up to 94% by volume of air. These embodiments have exceptional heat or thermal insulation yet maintain excellent flexibility and tactility; and therefore, are suitable for gloves where finger dexterity is generally necessary. It is noted that such plate materials are similar to those used in thermal insulating tiles used on the space shuttle. However, it is believed that such materials have not been affixed as discreet plates on a flexible substrate to yield a highly thermal insulating fabric as in the present inventions. Further, in other embodiments, substrate 554a, 554b can comprise heat insulating materials such as Kevlar®, Nomex, polyester, cotton, or combinations thereof.

In another embodiment illustrated in FIG. 9, flexible substrate 614 can comprise a composite substrate. It is noted, however, that a composite substrate can comprise compressible and/or non-compressible materials or combinations thereof. In some embodiments, the composite substrate 614 comprises compressible layer 604 such as rubber and a thin layer of fabric 610 laminated over compressible 604. In some embodiments, fabric 610 is a woven fabric. In other embodiments, fabric 610 is a knit fabric. In one embodiment, substrate 614 comprises neoprene or similar composite fabrics or materials. Neoprene is a material available in selected thicknesses and often used in items such as wetsuits and support bandages.

It has been discovered that a compressible material, such as Neoprene, can be a suitable substrate material for many applications requiring abrasion and wear resistance. Plates 602 are affixed to the top surface 611 of substrate 610. When plates 602 comprising, for example, epoxy resin, are printed or otherwise affixed on neoprene substrate 614, plates 602 tend to permeate fabric layer 610 and bond to both compressible or rubber layer 604 and fabric layer 610 leading to a relatively strong bond that has relatively high resistance to delamination.

Fabric assembly 600 can be advantageously used in gloves worn for work and sports applications. Fabric assembly 600 works well due to relatively high abrasion resistance and because neoprene is highly flexible, comfortable to wear, and is insulating and water-resistant. For some embodiments, the thickness of the neoprene is in the range of 0.5 to 2 millimeters but other thickness ranges can be appropriate. It is important to note, however, that materials of plates 602 are not limited to epoxy or phenol-based resins. Plates 602 can also comprise the same materials used in plates 552a and 552b affixed with an additional adhesive layer.

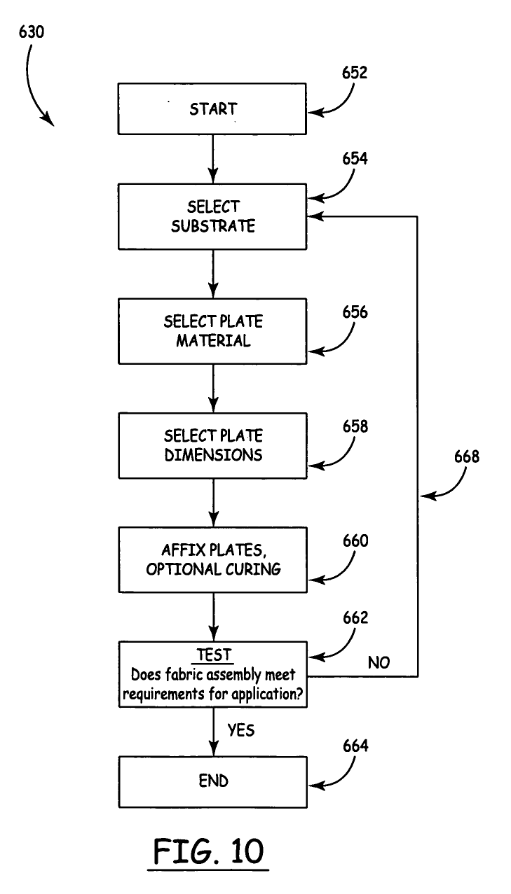

FIG. 10 illustrates method 650 for making or developing abrasion and wear resistant fabrics according to embodiments of the present invention. The method or process of making abrasion and wear resistant fabrics that are also optionally heat resistant starts at step 652. Such fabrics can be made for protective, sporting, work or leisure applications, such as for garment fabrics used in cycling, motorcycle riding, snow mobiling, skiing, wetsuits, knee pads, gloves, boots, and like applications. Other applications include fabrics used in objects such as soft-sided luggage, backpacks, tarps, roofs for convertible cars, and the like.

At step 654, the substrate material is selected that is appropriate for the intended application. As discussed above, neoprene has been forced to work particularly well for some applications having cold and/or wet environments. In other applications, woven or knit substrate fabrics have been selected such as comprising polyester, cotton, Kevlar® or nylon. Embodiments with non-woven fabric substrates like leather or vinyl can be useful for some applications such as jackets, pants, gloves, boots, bags, etc.

At step 656, plate materials are selected. Plate materials can be resins such as epoxy or phenol based resins that are capable of being solid or hard or composite materials such as ceramics as described above. It is generally preferred that plate material has tensile strength higher than 100 kgf/cm² (typical epoxy tensile strength when cured of approximately 700 kgf/cm²). Step 656 also includes selecting adhesives for affixing plates to the substrate fabric, if necessary, especially for solid or hard materials like ceramics as described above. In some embodiments, additives can be added to the resins in order to increase abrasion and/or wear resistance when appropriate. Examples of additives include alumina or titanium particles or ceramic beads. Resin materials can also be specifically selected for their heat resistant properties.

At step 658, plate dimensions can be selected. Plate dimensions include plate thickness, gap width, plate diameter and/or maximum dimension, and plate shape. Generally, as described previously, the gap width and other dimensions should be comparable in dimension to the plate thickness so the fabric assembly is sufficiently flexible while resisting abrasion. For example, the flexibility of fabric used in gloves would normally be more flexible than fabric used in a motorcycle jacket. Also, gap width normally is sufficiently small or narrow to prevent direct contact between substrate and the abrading object or surface. However, narrow gap widths generally lead to less flexibility. Smaller gaps also tend to inhibit heat transfer to the flexible substrate through the gaps. Therefore, these factors or considerations should be balanced in designing the fabrics of the present invention for a particular application.

In the present inventions, plate dimensions are selected so that plate diameter is in the range of approximately 20 to 100 mils and plate maximum dimension is in the range of approximately 20 to 200 mils. The plates are shaped as polygons such as equilateral hexagons; curved shapes; or composite shapes arrayed in a pattern with gap widths between adjacent plates in the range of 5 to 40 mils. The plate thickness is also in the range of 5 to 40 mils. In other embodiments, plate thickness and gap width is in the range of 0 to 20 mils.

Step 660 includes affixing plates on to the top surface of the flexible substrate. As described above, the plates can be printed onto the substrate using conventional screen printing techniques, without additional adhesives. When hard materials are used for plates, a layer of adhesive can be applied or laminated to the top surface of the flexible substrate and the plates then affixed. Optionally, fabric assembly can be cured to solidify or harden plates and/or adhesive layer, such as by heat or ultraviolet curing.

Step 662 is optional and includes testing the sheet assembly to determine if requirements for the selected application are met. Testing can be performed using typical abrasion testing apparatus or other tests designed to simulate conditions for the selected application. If the fabric assembly meets requirements, the method ends at block 664. The requirements can include abrasion, wear, cut, tear and puncture resistance, flexibility, comfort, heat insulation, and other requirements appropriate for the intended application. If more iterations are necessary, the method returns to step 654 of selecting the same or another substrate. The method 650 continues until a suitable fabric is designed or developed for the intended application that meets requirements.

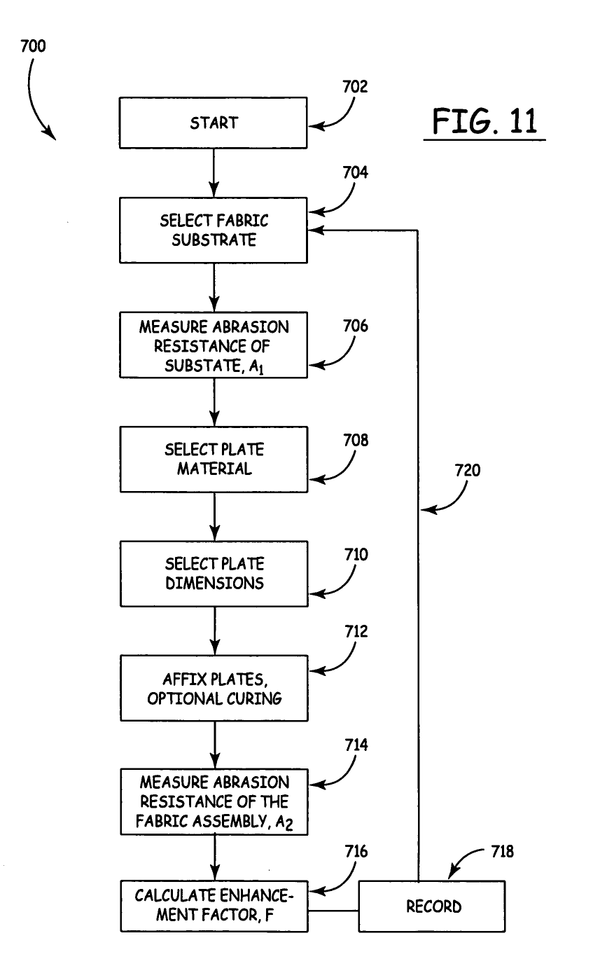

FIG. 11 illustrates method 700 for enhancing the abrasion and/or wear resistance of flexible substrates by affixing a plurality of plates arrayed to a flexible substrate, as described in greater detail above. At step 702, an abrasion and wear resistant fabric is desired or needed for one or more applications. Often, it is desirable to enhance the abrasion resistance of an entire substrate fabric. Alternately, abrasion enhancement can be limited to selected locations on the substrate, such as the elbow area of a jacket or the knee area of pants.

In the present embodiments and methods, abrasion resistance can be enhanced in the range of 2 to 200. In other embodiments, abrasion enhancements are a factor in the range of 5 to 100, 10 to 50, and 12 to 30, respectively. In some embodiments, a fabric substrate can be enhanced to a selected level so that the inventive fabrics can be provided a rating for abrasion and/or wear resistance, such as medium, high, etc., each with an appropriate range of abrasion resistance of some particular numerical unit or units.

Another desirable feature of the present inventions is that the fabric assembly is considered attractive. In fabrics such as used in motorcycle jackets, pants, and the like, the plates can be colored to match or contrast with the fabric substrate. Also, the plates can be arrayed in attractive patterns. It is also possible that plate patterns and/or colors can be selected to form images or lettering due to the small yet discrete characteristics of the affixed plates. The affixed plates can also be made to be heat insulating, which can be useful, for example, in protecting the legs of a motorcycle rider from engine heat.

Returning to FIG. 11, at step 704, the flexible substrate is selected as step 654 in FIG. 10. At step 706, the abrasion and/or wear resistance of the flexible substrate can be measured. The units of the measurement can be any unit associated with abrasion and/or wear resistance. One example of a unit of abrasion resistance is the number of cycles sustained before failure in an abrasion testing machine that conforms, for example, to ASTM standards. Other examples of units can include time to failure, speed of the abrading object at fabric failure, surface roughness of the abrading object at fabric failure, downward force at failure, etc. The abrasion and/or wear resistance measurement can be labeled A1 as shown.

At step 708, the plate material is selected as described in step 650 in FIG. 10. At step 710, the plate dimensions are selected as in step 658. At step 712, plates are affixed with optional adhesive and/or curing as described above.

At step 714, the abrasion resistance of the fabric assembly can be measured or tested as described in step 706. The abrasion and/or wear resistance of the fabric assembly can be labeled A2. At step 716, the enhancement factor is calculated as F=A2/A1. In some embodiments, the factor F can be in the range of 2 to 200. In other embodiments, the factor F can be in the range of 5 to 100, 10 to 50 and 12 to 30, respectively. Results for F can be tabulated for various substrate fabrics, plate materials and dimensions and put in a usable form that can be accessible to customers, (e.g. a catalog). The process returns through loop 720 to step 704 so that the flexible substrate, plate material or dimensions, etc. can be adjusted as necessary. Thus, the process can be iterative.

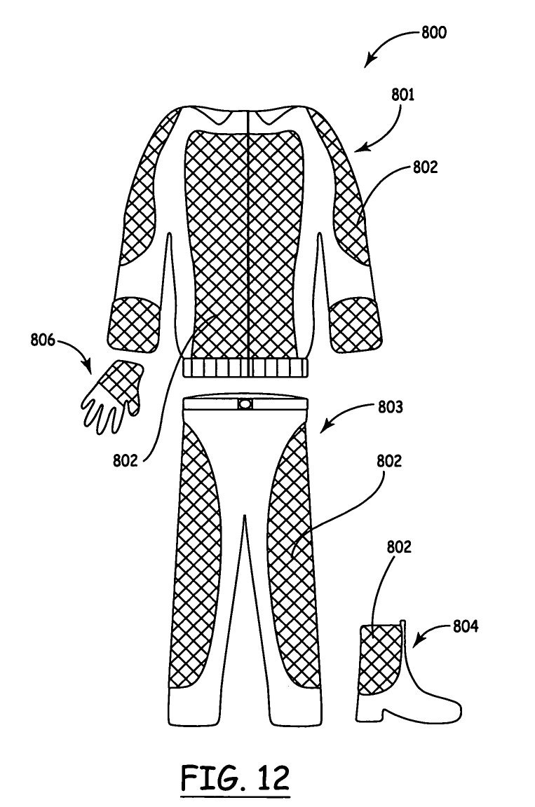

FIG. 12 illustrates an embodiment of the present inventive fabrics. Illustrative protective suit 800 comprises jacket 801, pants 803, boots 804 and gloves 806. Fabric patches 802 are positioned in areas needing enhanced or extra abrasion and wear resistance as well as optional heat resistance. The patches 802 can be affixed such as by being sewn onto jacket 801, pants 803, boots 804 and gloves 806 or attached by other means, such as with adhesives or other bonding agents. In other embodiments, patches 802 are pieced together with other fabric pieces, i.e. leather or vinyl and sewn together and otherwise attached to the garments 801, 803, 804 and 806.

A reduction to practice example is provided to show how the current invention improves the abrasion resistance of fabrics. Abrasion resistance of a woven (crepe style) polyester fabric of thickness approximately 8 mils was tested using Taber 5130 Abraser tester (ASTM D 3884), with an H-18 wheel at 72-rpm speed and 1000-gram load. The fabric failed by being worn through after 85 cycles. Then, densely spaced epoxy resin plates were deposited or affixed on the fabric substrate by conventional screen printing techniques, as in the present inventions. The fabric assembly was then cured. The plates were identical hexagon-shaped plates that formed a dense, surface-filling array as illustrated at least in FIGS. 1-3. Each plate was approximately 70 mils in diameter and approximately uniformly 12 mils thick. The gap width between two neighboring adjacent plates was measured as approximately 13 mils. The cured resin plates had a hardness of approximately Shore D 80. The reinforced fabric was flexible and was suitable for use in many garment applications, including gloves. The fabric assembly was also resistant against abrasion, tear, snag and puncture because the flexible substrate was well protected by the densely spaced resin plates. It is noted that the fabric assembly also provided relatively good heat resistance.

An identical ASTM test (ASTM D 3884, H-18 wheel, 72 rpm at 1000 g load) was then performed on this fabric assembly. The material lasted 1250 cycles before failure by being worn through. Thus, the enhancement factor F obtained is approximately 1250 divided by 85, which equals approximately 15 in abrasion resistance enhancement of the inventive fabric assembly over the original flexible substrate fabric.

Although the present invention has been described with reference to preferred embodiments, workers skilled in the art will recognize that changes may be made in form and detail without departing from the spirit and scope of the invention.

What is claimed is:

1. An abrasion and wear resistant fabric assembly comprising:
a flexible substrate having a top surface; and
a plurality of non-overlapping plates affixed to the top surface of the substrate, wherein the plates have a substantially uniform thickness of approximately 5 to 20 mils.

2. The abrasion and wear resistant fabric of claim 1, wherein the substantially uniform thickness is approximately 5 to 10 mils.

3. The abrasion and wear resistant fabric assembly of claim 1, wherein the plates define a plurality of continuous gaps between adjacent plates, each gap having a width approximately 5 to 20 mils.

4. The fabric assembly of claim 3, wherein the plates each have a maximum dimension in the range of 20 to 200 mils.

5. The fabric assembly of claim 3, wherein the plates are identical.

6. The fabric assembly of claim 3, wherein the plates each have a diameter in the range of 20 to 100 mils.

7. The fabric assembly of claim 5, wherein the plates are shaped as a polygon.

8. The fabric assembly of claim 7, wherein the polygon is an equilateral hexagon.

9. The fabric assembly of claim 8, wherein the equilateral hexagon has a diameter in the range of 20 to 100 mils.

10. The fabric assembly of claim 9, wherein the diameter is in the range of 20 to 80 mils.

11. The fabric assembly of claim 5, wherein the plates have a curved shape.

12. The fabric assembly of claim 11, wherein the curved shape is approximately circular.

13. The fabric assembly of claim 3, wherein the plates are non-identical relative to each other.

14. The fabric assembly of claim 3, wherein the plates comprise a polymeric resin.

15. The fabric assembly of claim 14, wherein the polymeric resin is epoxy.

16. The fabric assembly of claim 3, wherein the plates comprise a composite material.

17. The fabric assembly of claim 16, wherein the composite material comprises a ceramic material.

18. The fabric assembly of claim 16, wherein the composite material comprises a plastic.

19. The fabric assembly of claim 3, wherein the flexible substrate comprises a woven or knit fabric.

20. The fabric assembly of claim 19, wherein the flexible substrate comprises polyester.

21. The fabric assembly of claim 19, wherein the flexible substrate comprises cotton.

22. The fabric assembly of claim 19, wherein the flexible substrate comprises Kevlar®.

23. The fabric assembly of claim 19, wherein the flexible substrate comprises nylon.

24. The fabric assembly of claim 3, wherein the flexible substrate comprises a non-woven material.

25. The fabric assembly of claim 24, wherein the non-woven material comprises leather.

26. The fabric assembly of claim 3, wherein the substrate comprises a compressible material.

27. The fabric assembly of claim 26, wherein the substrate further comprises a fabric laminated to the compressible material.

28. The fabric assembly of claim 3, wherein the flexible substrate comprises neoprene.

29. An abrasion and wear resistant fabric assembly comprising:
a flexible substrate having a top surface; and
a plurality of non-overlapping plates affixed to the top surface of the substrate, the plurality of plates arrayed such that a plurality of gaps are defined between adjacent plates, wherein the plates have a substantially uniform thickness, and wherein the plurality of plates enhances the abrasion resistance of the flexible substrate by a selected factor.

30. The abrasion and wear resistant fabric assembly of claim 29, wherein the plurality of plates comprises a material that selectively increases heat resistance of the flexible substrate.

31. The fabric assembly of claim 29, wherein the plate thickness is approximately 5 to 40 mils.

32. The fabric assembly of claim 29, wherein the plates comprise polymeric resin with tensile strength greater than 100 kgf/cm².

33. The fabric assembly of claim 29, wherein the factor ranges from 2 to 200.

34. The fabric assembly of claim 33, wherein the factor of abrasion resistance enhancement ranges from 5 to 100.

35. The fabric assembly of claim 34, wherein the factor of abrasion resistance enhancement ranges from 10 to 50.

36. The fabric assembly of claim 35, wherein the factor of abrasion resistance enhancement ranges from 12 to 30.

37. A method of making an abrasion and wear resistant fabric assembly comprising:
selecting a flexible substrate having a top surface;
selecting a heat resistant plate material capable of being solid and affixed to the top surface of the flexible substrate; and
affixing the plate material on the top surface of the flexible substrate, the plate material forming a plurality of non-overlapping plates having a substantially uniform thickness of approximately 5 to 40 mils.

38. A method of making an abrasion and wear resistant fabric assembly comprising:
selecting a flexible substrate having a top surface;
selecting a plate material capable of being solid and affixed to the top surface of the flexible substrate; and
affixing the plate material on the top surface of the flexible substrate, the plate material forming a plurality of non-overlapping plates having an approximate uniform thickness in the range of 5 to 40 mils, the plates enhancing the abrasion resistance of the flexible substrate by a selected factor.

39. An fabric assembly comprising:
a flexible substrate having a top surface; and
a plurality of non-overlapping plates affixed to the top surface of the substrate, wherein the plates comprise a low thermal conductivity material.

40. The fabric assembly of claim 39, wherein the low thermal conductivity material comprises porous ceramic.

41. The fabric assembly of claim 40, wherein the low thermal conductivity material further comprises silica glass fiber.

42. The fabric assembly of claim 41, wherein the low thermal conductivity material comprises an air volume of up to approximately 94%.

43. The fabric assembly of claim 42, wherein the substrate comprises a heat resistant fabric.
